(19) United States
(12) Patent Application Publication
(10) Pub. No.: US 2007/0093946 A1
(43) Pub. Date: Apr. 26, 2007

(54) Methods and apparatus for unmanned vehicle command, control, and communication

(75) Inventor: Iftah Gideoni, Kfar Vitkin (IL)

Correspondence Address: FISH & NEAVE IP GROUP;ROPES & GRAY LLP, 1211 AVENUE OF THE AMERICAS, NEW YORK, NY, 10036-8704, US

(73) Assignee: PROXY AVIATION SYSTEMS, INC., Germantown, MD (US)

(21) Appl. No.: 10/575,803

(22) PCT Filed: Oct. 22, 2004
(86) PCT No.: PCT/US04/35115

§ 371 Date: Apr. 11, 2006

(51) Int. Cl. G05D 1/00; G01C 22/00

(52) U.S. Cl. 701/24; 701/23

(57) ABSTRACT

Methods and apparatus are provided for command and control of an unmanned vehicle (“UV”). A preferred embodiment of the invention includes a Virtual Pilot (“VP”), which includes a Brain and an Arena The Brain includes rules governing the behavior of the UV and information on missions to be performed. The Arena includes state information about the UV and its environment. UVs in a swarm communicate with each other, as well as with various ground stations, through regular updates. Backup schemes are provided to deal with the failure of a UV module, thereby providing partial degradations in performance. Communication among the UVs and ground stations of a system employ a probabilistic scheme that promotes high spectral efficiency.

### BACKGROUND OF THE INVENTION

This invention relates to the field of unmanned vehicles (“UVs”). Specifically, this invention relates to the command, control, and communication of UVs.

The use of UVs can provide substantial benefits in many situations. Most previously known UVs rely on remote control by a human operator. The operator receives information from the vehicle (e.g., visual data from cameras and equipment data from sensors) and uses this information to operate the vehicle appropriately. This approach decreases the physical strain and risk imposed on the human operator, as compared to having the operator in the vehicle itself. Unfortunately, this approach also relies on the availability of effective, substantially continuous communication.

In many circumstances, communication between the vehicle and the operator may be interrupted. For instance, the vehicle may travel out of range, the communication path between the vehicle and the operator may be obstructed (e.g., by a mountain, the curvature of the earth, or atmospheric conditions), or the transmitted signals may be corrupted. This interruption is especially common in the use of unmanned aerial vehicles (“UAVs”), which typically travel long distances at a wide range of altitudes. Although many of the concepts and examples presented herein deal specifically with UAVs, it will be noted that the invention can be applied to UVs in general.

When communication is interrupted, many existing UVs are designed to react in a preset fashion. For instance, some UVs are configured to continue the command currently being executed until communication is re-established. Unfortunately, such an approach can result in flying straight into an obstacle, banking into the ground, etc. Other UVs are designed to return to their point of origin if their communication is significantly interrupted. Although this approach will prevent crashes in many cases, it can also result in a large number of aborted missions.

In addition to failures resulting from equipment and the like, many failed missions result from simple human error. The human operator, or someone with whom the operator interacts (either directly or indirectly) may provide instructions that result in sub-optimal operation of the UV. This problem is especially likely when teams of people work together to control multiple UVs.

In view of the foregoing, it would be desirable to provide methods and apparatus that enable a UV to operate with little or no guidance from human operators. It would also be desirable to reduce the amount of communication required by UVs, as well as the amount of human control involved in UV missions.

### SUMMARY OF THE INVENTION

In accordance with this invention, methods and apparatus are provided for command and control of a UV. A preferred embodiment of the invention includes a Virtual Pilot (“VP”), which preferably includes a Brain and an Arena, and is designed to emulate the behavior and decision-making of a human pilot. The static portion of the Brain preferably includes rules governing the behavior of the UV, which preferably are organized in a hierarchical structure. The dynamic portion of the Brain preferably includes information on missions to be performed by the UV. The missions preferably are organized in phases. A preferred embodiment of the invention allows modification of rules and phases by either rules or human intervention. The Arena preferably includes state information about the UV and its environment. This information preferably is received through sensors mounted on the UV, reports, and other suitable sources.

A distributed management system (“DMS”) of the invention manages swarms of UVs and multiple ground stations, collectively referred to as participants. Each participant preferably maintains a copy, or “reflection,” of the Brain and Arena of all other participants. These reflections, along with other elements of the UV architecture of the invention, allow a UV to deal with module failures with backup measures that permit at most a partial degradation in performance under most scenarios.

The invention greatly reduces the reliance of UVs on communication. Communication can be interrupted for extended periods of time without failure of the UV or termination of the mission. In addition, the amount of information that needs to be communicated is reduced. In an embodiment of the invention, participants communicate with each other using a collection of predefined time slices. Although each slice is assigned to a given participant (at least nominally), participants are not limited to transmitting during their assigned time slice. The decision of whether or not a participant will transmit in a given time slice is preferably based on several factors, including the likelihood that another transmission will interfere with the participant's transmission at the intended recipient. Urgent messages can preferably be transmitted using a non-probabilistic scheme, where interference is no longer a significant concern. The use of such a communication scheme results in efficient usage of available bandwidth.

The invention therefore advantageously provides methods and apparatus that enable a UV to operate with little or no guidance from human operators. UV robustness is improved while the amount of communication necessary in the UV system is significantly reduced.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram showing an illustrative single-UV system in accordance with the invention;

FIG. 2 is a block diagram showing illustrative human control of a traditional single-UV system;

FIG. 3 is a block diagram showing illustrative human control of a single-UV system in accordance with the invention;

FIG. 4 is a block diagram showing an illustrative DMS for a multi-UV system in accordance with the invention;

FIG. 5 is a tree diagram showing an illustrative organization for the static portion of a Brain in accordance with the invention;

FIG. 6 is a tree diagram showing an illustrative organization for the dynamic portion of the Brain in accordance with the invention;

FIG. 7 is a state diagram showing illustrative state machine modification in accordance with the invention;

FIG. 8 is a block diagram showing illustrative backup measures for handling VP failure in accordance with the invention;

FIG. 9 is a block diagram showing illustrative backup measures for handling primary communication failure in accordance with the invention;

FIG. 10 is a block diagram showing illustrative backup measures for handling junction failure in accordance with the invention;

FIG. 11 is a node diagram showing an illustrative communication scenario for a multi-UV system;

FIG. 12 is a diagram showing an illustrative time division scheme for a communication scheme in accordance with the invention;

FIG. 13 is a flow chart showing an illustrative calculation of a probability of communication interference in accordance with the invention; and

FIG. 14 is a flow chart showing an illustrative decision of whether or not a given participant should transmit in accordance with the invention.

### DETAILED DESCRIPTION OF THE INVENTION

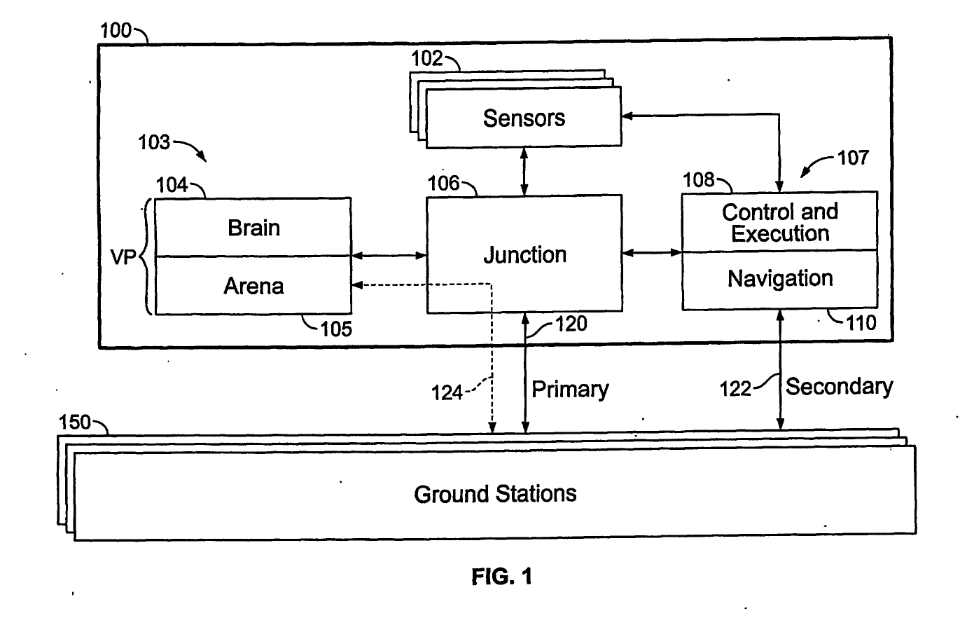

FIG. 1 shows a preferred embodiment of an illustrative single-UV system in accordance with the invention. UV 100 preferably includes sensors 102, virtual pilot (“VP”) 103, junction 106, and controller module 107. Sensors 102 include equipment that detects information about UV 100 or its environment. For instance, sensors 102 may include payload such as cameras mounted on UV 100, radar, laser designators, range finders, equipment status indicators, or any other suitable sensing equipment.

VP 103 preferably includes circuitry and software that emulates the function of a human pilot in controlling UV 100. In particular embodiments of the invention, VP 103 preferably can automatically perform tasks such as takeoff and landing (in the case of a UAV), cruising, maneuvering around obstacles, etc., reducing the amount of communication to ground stations and freeing up human users to make more high-level decisions. VP 103 preferably includes Brain 104, which preferably includes a plurality of rules governing the behavior of the VP, as well as information on missions to be performed by UV 100. VP 103 preferably also includes Arena 105, which preferably reflects environmental information, such as weather reports, information on threats and obstacles, target information, and terrain maps. Arena 105 also preferably includes the state and condition vectors of all ground stations, UVs, and other friendly elements (which may or may not participate in the communication network). Thus, the data contained in Brain 104 correspond roughly to the missions, doctrines, checklists, and other knowledge of a human pilot. On the other hand, Arena 105 corresponds roughly to the physical state of the world which may be of interest to the pilot, and which the pilot uses for decision-making.

Junction 106 preferably serves as an interface between the various components of UV 100, and preferably also facilitates communication with ground stations 150. Controller module 107 preferably includes control and execution circuitry 108, as well as navigation circuitry 110. Control and execution circuitry 108 preferably includes circuitry that modifies the state of onboard equipment, such as by directing cameras or otherwise configuring instruments. Navigation circuitry 110 preferably includes circuitry that controls the flight path of UV 100, such as servos that adjust the wing flaps if UV 100 is a UAV. In addition, navigation circuitry 110 is preferably capable of performing functions consistent with auto-pilot operation. Control and execution circuitry 108 may overlap with navigation circuitry 110 to some extent.

Junction 106 preferably is capable of bidirectional communication with sensors 102, VP 103, and controller module 107. In addition, sensors 102 may communicate directly with controller module 107. Junction 106 preferably communicates with ground stations 150 via primary communication channel 120. In contrast, controller module 107 preferably communicates with ground stations 150 via secondary communication channel 122. In an embodiment of the invention, primary channel 120 may have higher bandwidth than secondary channel 122. VP 103 preferably is logically connected to ground stations 150 via junction 106 and primary channel 120, as indicated by dotted arrow 124. Ground stations 150 preferably include equipment and personnel that manage and support UV 100. In some embodiments of the invention, at least some of ground stations 150 include copies or “reflections” of Brain 104 and Arena 105. These reflections are maintained through frequent updates, as explained below.

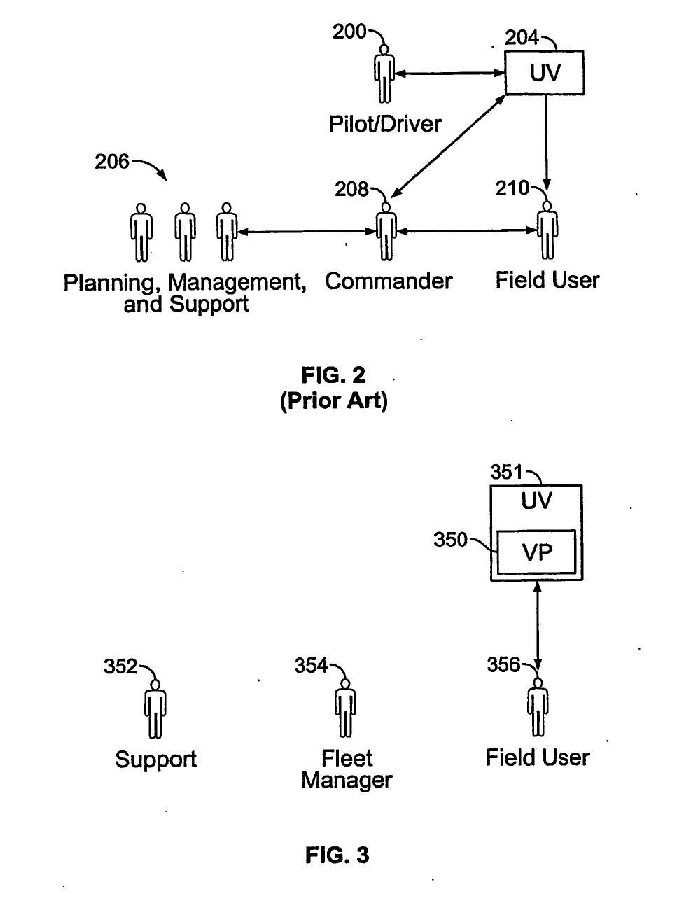

FIG. 2A shows illustrative human control of a traditional single-UV system. Pilot/driver 200 is responsible for continuously flying or driving UV 204 from a remote location. Commander 208 controls the lower-level behavior of UV 204, such as informing UV 204 of a certain destination, instructing UV 204 to activate a portion of its payload, or initiating cooling of equipment on UV 204. Commander 208 is also responsible for making mission-level decisions for UV 204. Field user 210 monitors payload output from UV 204, such as viewing video streams from cameras mounted on UV 204, and requests services from commander 208. In addition to these parties, who are directly involved in the operation of the UV, planning, management, and support staff 206 work in the background to manage unused UVs, determine upcoming mission goals and logistics, and perform other suitable background functions.

FIG. 3 shows illustrative human control of a single-UV system in accordance with the present invention. VP 350 resides directly on UV 351, and typically assumes the responsibilities formerly assigned to pilot/driver 200, including continuously piloting or driving UV 351 and troubleshooting the systems of UV 351 in the event of failure. In addition to freeing up a human operator from having to operate UV 351, VP 350 also dramatically reduces the amount of communication required between UV 351 and its ground stations. VP 350 also assumes most, if not all, of the duties formerly assigned to UV commander 208, such as controlling payload operation, modifying equipment settings, and making mission level decisions.

Field user 356 still performs essentially the same role as a field user in the previously known system shown in FIG. 2, monitoring payload output and making appropriate decisions. However, field user 356 does not need to communicate with another human user to carry out his decisions. Instead, field user 356 communicates directly with VP 350 to command its Tasking, which is described below. VP 350 is in turn responsible for the low-level details of UV execution. Thus, only one human operator is needed to directly control UV 351 (as opposed to three, as shown in FIG. 2), and the operator is focused on relatively high-level decision-making.

As before, some amount of background staff is needed. Fleet manager 354 matches resources (e.g., swarms of UVs) to requirements. Support staff 352 manages the resources not currently involved in a mission. Note that, because the amount of necessary human control of UV 351 is greatly reduced by the use of VP 350, the background tasks are significantly reduced in both number and complexity. In addition, in either the previously known system or the system of the invention, a higher level command structure would probably exist to make ultimate decisions on certain payload deployments.

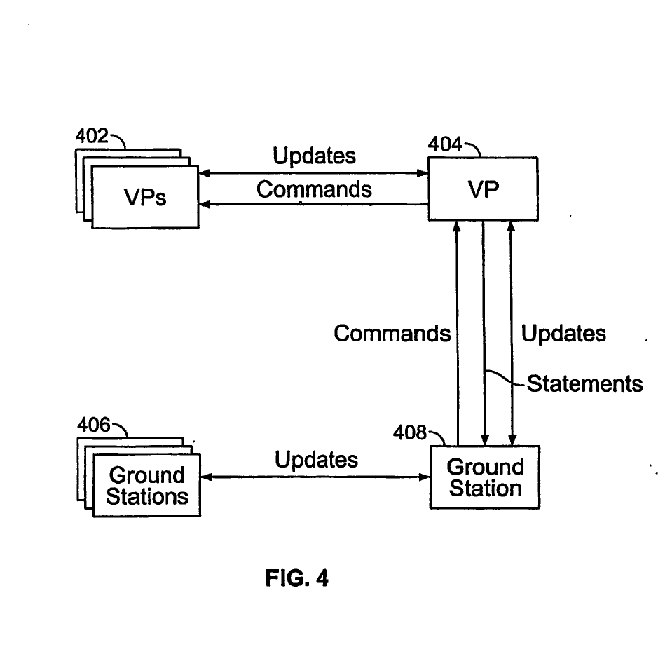

FIG. 4 shows an illustrative distributed management system (“DMS”) for a multi-UV system in accordance with the invention. VP 404 is mounted on a UV, and preferably communicates with the other VPs 402 in its group, known as a “swarm.” VP 404 preferably exchanges periodic updates with VPs 402. These updates preferably are used to maintain reflections of the Brain and Arena of each VP on the other VPs in the swarm. These reflections permit more informed and efficient communication between the VPs, as well as providing redundancy for backup purposes.

The Brain and Arena reflections are preferably maintained as follows. Each UV or ground station (referred to herein as a “participant”) preferably includes a vector or array pointing to the Brain of each participant, including its own. The UV or ground station is responsible for keeping its own Brain up-to-date and communicating changes in its Brain to other participants.

Similarly, each UV or ground station preferably includes a vector or array containing Arena information for each participant. As with the Brain reflections, each UV or ground station is responsible for keeping its own Arena information up-to-date (e.g., by keeping track of readings from onboard sensors) and communicating changes in its Arena information to other participants. In a preferred embodiment of the invention, a subset of the Arena information may be identical across all the participants. This subset of information may include, for example, terrain maps, weather reports, and locations of restricted areas. It would be redundant to maintain one copy of this subset for each participant. Thus, only one copy of this common Arena information preferably is maintained on each participant.

As mentioned before, VP 404 can communicate with ground station 408, which preferably also contains Brain and Arena reflections consistent with those maintained in VP 404. These reflections preferably are maintained through periodic updates. In addition, VP 404 preferably can send messages to ground station 408, informing ground station 408 of navigation status, equipment status, or any other suitable information. In response, ground station 408 preferably can send commands to VP 404, such as those issued by field user 356 in FIG. 3. Ground station 408 preferably also communicates with other ground stations 406. Updates preferably are exchanged between ground stations 406 and ground station 408, preferably allowing the maintenance of Brain and Arena reflections similar to those maintained in the VPs.

In an embodiment of the invention, there exists a background process that preferably helps detect differences between the Brain and Arena reflections maintained across the participants. This process preferably includes exchanging hashcodes computed from the contents of the vectors of Brain and Arena information maintained at each participant. If a discrepancy is detected in these hashcodes, appropriate action can be taken to discover the cause of that discrepancy.

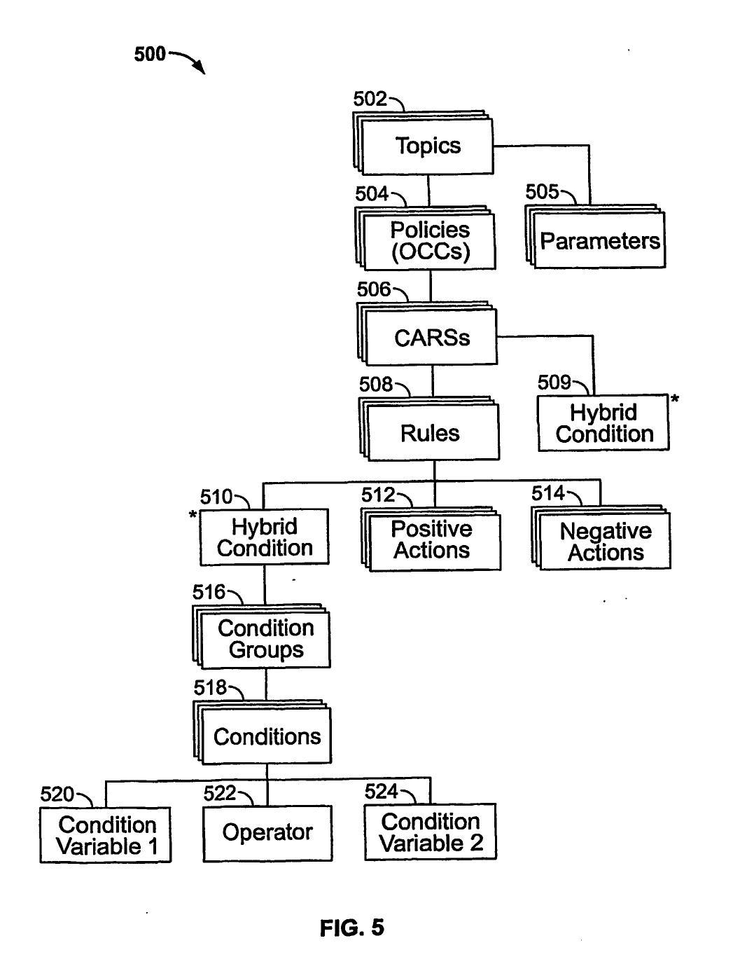

FIG. 5 is a tree diagram showing an illustrative organization for the static portion 500 of the Brain 104 in accordance with the invention. At the top level the Brain preferably is organized by broad topics 502, such as Navigation, Payload, Onboard Systems, Mission Flow, and Tasking. The significance of the Tasking topic is explained below. Each topic has an associated set of policies 504 and an associated set of parameters 505. For instance, the Payload topic can include policies such as Off (e.g., cameras not receiving input), Scan Target, Scan and Report Movements, and Manual (e.g., respond only to user commands). Parameters 505 include static information corresponding to its topic, such as camera settings under Payload.

Each policy is represented by an Operational CARS Collection (“OCC”), which includes a plurality of Condition-Action Rules Sets (“CARSs”) 506. For instance, the Scan Target policy under the Payload topic might include CARSs corresponding to scanning a point target, scanning a route, or scanning an area. Proceeding further down the hierarchy, each CARS includes a set of associated rules 508 and an associated hybrid condition 509. The rules 508 in a given CARS take effect if the associated hybrid condition 509 evaluates to be true. Further description of hybrid conditions is given below.

In an embodiment of the invention, each rule preferably is a condition-action rule preferably including a hybrid condition 510, a set of positive actions 512 to be executed if the hybrid condition is true, and a set of negative actions 514 to be executed if the hybrid condition is false. In another embodiment of the invention, each rule could include only positive actions, and no negative actions. Under this scenario, the negative actions would be included in a separate set of rules.

Each hybrid condition 510 preferably is a logical statement that evaluates to either true or false. Each hybrid condition 510 preferably includes a set of condition groups 516, combined with a logical OR operator. In turn, each condition group 516 preferably includes a set of conditions 518, combined with a logical AND operator. Finally, each individual condition 518 preferably includes a first condition variable 520, an operator 522 (e.g., EQUALS, LESS THAN, or NOT EQUAL TO), and a second condition variable 524. It is well known in the art that any logical statement can be expressed as a hybrid condition of the form described above. Therefore, this structure provides universal coverage of logical statements. Alternatively, another suitable hybrid condition structure (e.g., conditions combined with a logical OR and condition groups combined with a logical AND) can be used.

The hierarchy shown in FIG. 5 effectively organizes the rules dictating how a UV will perform in various situations. This organization makes management of the rules modular and efficient, while still permitting a great deal of flexibility. For instance, rules falling under the topic of Tasking can modify the conditions corresponding to rules and CARSs of other topics, such as Navigation or Payload. Tasking includes high-level policies such as Monitor for Fires, Follow Leader, Act as Leader, Act as Independent UV, Work with End User, or Land at Destination. Selecting such a policy can result in the selection of policies falling under other topics, such as dictating how the Payload topic's Scan Target policy is carried out.

Additional flexibility is provided at the rule level. For instance, a typical rule may detect that the oil pressure on a UV is above a certain acceptable limit, and make appropriate adjustments to onboard equipment. In addition to evaluating conditions based on physical factors (e.g., from the surrounding environment or the UV's equipment) and performing physical actions designed to address those conditions, rules can also trigger the execution of other rules. In one embodiment, a rule's actions may include setting a flag, which another rule preferably uses as an input to its hybrid condition. For example, the Brain may include a “Critical” flag, which can be set to true if any number of unacceptable conditions occurs. This “Critical” flag can in turn trigger its own set of actions (e.g., landing at the nearest base).

In addition, a rule's hybrid condition does not have to be based on simple observed inputs—it can also be determined by computation. For example, a variable in a hybrid condition could involve computing the distance from the current UV to its nearest neighbor in the swarm, and comparing that distance to the average distance to all other UVs in that swarm. Even the hybrid conditions themselves allow a wide range of possible expressions. For instance, a condition can itself be a hybrid condition.

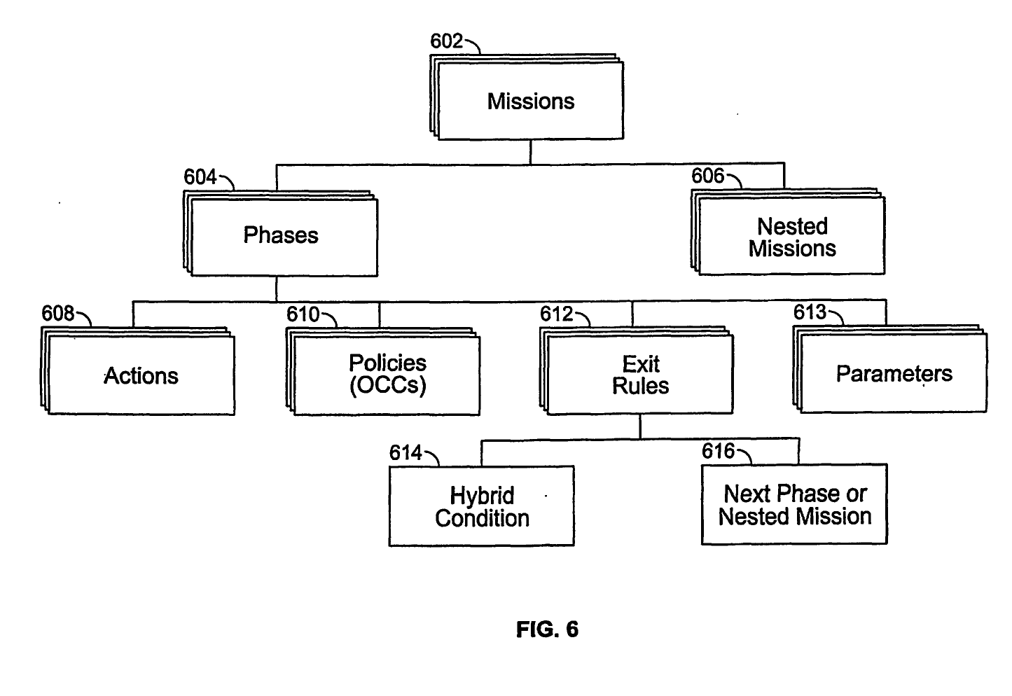

While the structure shown in FIG. 5 can be seen as representing the static component of the Brain, the structure shown in FIG. 6 can be viewed as representing the dynamic portion of the Brain. In accordance with the invention, the Brain preferably includes various missions 602, corresponding to the high-level tasks assigned to a particular UV. Each mission 602 can include phases 604, nested missions 606, or both. In other words, missions 602 are arranged in an ordered tree structure where the phases are the terminal “leaves.”

Each phase 604 may be defined by several components, including actions 608, policies (represented by OCCs) 610, exit rules 612, and parameters 613. An exit rule 612 preferably determines when a phase is over and how it should be terminated. Each exit rule 612 preferably includes a hybrid condition 614, which evaluates to true when the phase is finished, and also includes the next phase or nested mission 616 to which to proceed. Parameters 613 include information necessary to execute the phase, such as the coordinates of a target, and may be static or dynamic. In addition, parameters 613 are preferably organized by topic.

The mission organization shown in FIG. 6 facilitates efficient planning and execution of missions. As a UV proceeds through a mission, its VP keeps track of what phase is being executed, what rules and parameters govern that phase, and how to transition to the next phase. Thus, the division of missions into individual phases with associated transitions makes this component of the Brain similar to a conventional state machine. However, some aspects of the invention, such as those described in connection with FIG. 5, provide greater adaptability than traditional state machine approaches. For instance, the execution of a rule's actions may affect the phases and exit rules of a mission, which corresponds roughly to the alteration of states and transitions of a state machine.

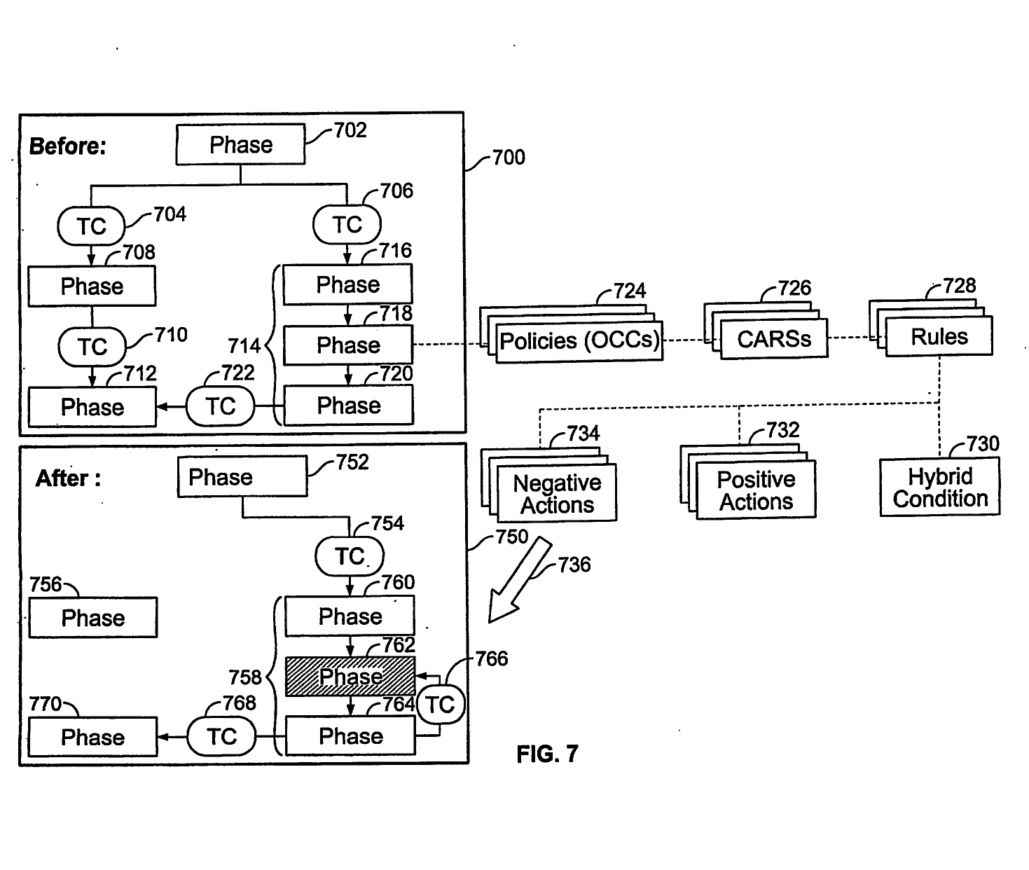

For instance, FIG. 7 shows an illustrative modification of a state machine in accordance with the invention. State machine 700 represents the initial state machine of an illustrative mission. The mission starts at phase 702. If transition condition (“TC”) 704 is satisfied, execution proceeds to phase 708. On the other hand, if TC 706 is satisfied, execution proceeds to phase 716, which is the first phase of nested mission 714. In this example, phases 716 and 718 are proceeded through unconditionally, executing their associated actions and then transitioning to the next phase in nested mission 714. It is not until phase 720 that another TC is required. At this phase, TC 722 can trigger a transition to phase 712. Note that phase 712 can also be entered via TC 710 from phase 708.

In accordance with the invention, some phases of a given mission may contain rules that can modify the phases and transitions of a mission's state machine. For example, suppose that phase 718 includes policies (represented by OCCs) 724, each of which include one of CARSs 726, each of which include one of rules 728. Each rule can include a hybrid condition 730, positive actions 732, and negative actions 734. In this particular example, suppose that one of the negative actions 734 modifies state machine 700, so that the resulting state machine 750 has substantially different phases and transitions. This modification is indicated by arrow 736.

The modification of state machine 700 can be achieved by any appropriate means. For instance, a mission can be represented by a vector or array of pointers. Each pointer can point to a nested mission or phase, which can in turn be represented by another vector or array of pointers. Thus, changing a phase's exit rules or conditions can simply involve reassigning a pointer or changing a field in the data structure corresponding to that pointer.

After the execution of that particular action, state machine 7.00 has been reconfigured as state machine 750 as follows. The mission begins at phase 752, which corresponds to phase 702. However, the exit rules are now different from those of phase 702. For example, it is no longer possible to enter phase 756, which corresponds to phase 708, while it is still possible to enter phase 760, which corresponds to phase 716. However, this transition is now governed by TC 754, which may be different from TC 706. Such modification of phases and transitions that have already been traversed may be significant if this mission is executed again at a later time. Phase 760 is part of three-phase nested mission 758, whose first two phases 760 and 762 have unconditional transitions, as was true of corresponding phases 716 and 718. However, note that phase 764 can now transition to phase 762 through TC 766, or to phase 770 through TC 768. In addition, there is now only one way to enter phase 770, whereas corresponding phase 712 could be entered in two ways.

Note that, upon execution of the negative action 734 that triggers modification 736, mission execution resumes at phase 762 of modified state machine 750. In an embodiment of the invention, phase 762 may include different actions from phase 718, different rules, different parameters, or any combination of the above. In addition, the execution of that action 734 can change the phases, transitions, or both of the state machine of another mission (e.g., a mission that has already been loaded into memory, for execution after the current mission). Furthermore, execution of that action 734 does not have to result in resumption of execution at phase 762 of state machine 750. Instead, execution can resume in any phase of any mission contained in Brain 104.

In addition, note that modification of the state machine does not have to occur during mission execution. State machine modification can occur during mission planning as well. For instance, a human user can use a graphical user interface (“GUI”) to modify the phases, transitions, or both of a mission's state machine. Also, even if the modification does occur during mission execution, it can still be performed by human intervention. The human user could monitor the progress of the mission, enter an appropriate change through a GUI, and wait for the change to be propagated to the onboard VP through appropriate communication.

The Brain and Arena functionality described above can be applied to achieve many different objectives. For instance, a phase of a mission may be dedicated to checking elements on a pre-flight checklist. Such an operation preferably includes instructing human staff on the runway to check various pieces of equipment (e.g., wheels, wings, etc.) and report their status to the VP. In addition, the VP can be used to enable automatic takeoff and landing, not just from and to its designated base or airfield, but also in an arbitrary, unmanned airfield. Such takeoff and landing operations would make use of Arena information regarding terrain, obstacles, and physical state of the UV within the environment.

Another example of functionality enabled by the Brain and Arena described above is the implementation of a Smart Camera Guide. This Smart Camera Guide is preferably implemented as a phase of a mission, and enables a UV to navigate itself while maintaining a direct line of sight to a given target. Such a feature may be useful, for example, in surveillance applications. The operation of the Smart Camera Guide preferably includes a merit function, whose value is determined by factors such as: physical terrain obstacles; regions of restricted airspace; desired inclination and azimuthal direction of the ideal line of sight; known weather conditions; the possible obstruction of another UV's line of sight; the aeronautical capabilities of the UV in question; and the capabilities of the observation package, including payload. This merit function can be used to calculate an optimal flight path for the UV. In addition, this flight path can be regularly adjusted as new information becomes available.

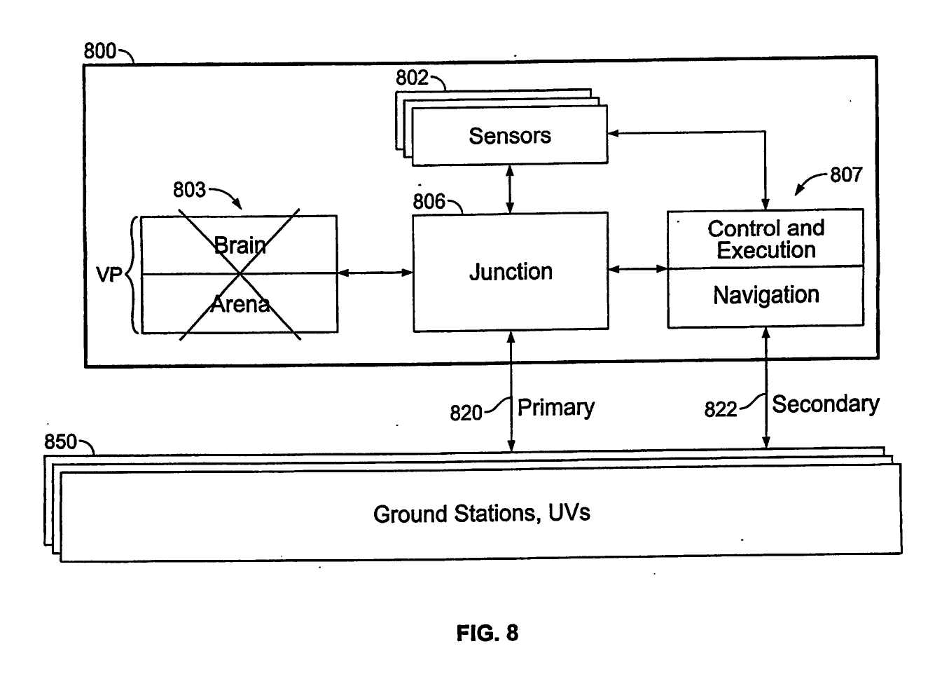

Because one benefit of the invention is increased robustness in the face of unreliable communication, it is also natural to provide backup measures to allow a UV to function acceptably even when some of its modules fail. Such backup measures are illustrated in FIGS. 8-10.

FIG. 8 shows illustrative backup measures for handling VP failure in accordance with the invention. The failure of VP 803 is indicated by an X through VP 803 in FIG. 8. Because of its complexity and the fact that a large part of its functionality is likely to be implemented in software, the VP is the component most susceptible to unexpected failure. In the event of VP failure, UV 800 is still able to perform its normal functions. Sensors 802 and controller module 807 function substantially as if the VP were still present. Secondary communication channels 822 can still be used to communicate with ground stations and other UVs 850.

However, because junction 806 can no longer communicate with an onboard VP, it resorts to communicating with the Brain and Arena reflections in ground stations and other UVs 850. Recall that these Brain and Arena reflections are periodically updated such that the Brain and Arena that would have been maintained on UV 800 are still accessible by appropriate communication through primary channels 820. It is assumed that ground stations and other UVs have sufficient memory and computation power to maintain such reflections. Thus, human users are able to continue directing the behavior of UV 800 as they normally would have. In addition, all onboard equipment except for junction 806 can continue operating as usual. Of course, complementary backup measures may be implemented in the rules of the Brain, or in any other suitable fashion. For instance, the Brain may contain rules that detect when the VP of UV 800 has been disabled, and communicate this knowledge to ground stations 850, which in turn can take appropriate actions.

In addition, the Brain and Arena reflections for UV 800 can preferably continue to operate even if primary channel 820 and secondary channel 822 are obstructed. For instance, assume that UV 800 is disconnected from all other participants for a certain period of time. During that time, the Brain and Arena reflections for UV 800, present in ground stations and other LWs 850, will remain active and simulate the operation of a Brain and Arena present on UV 800. This simulation will use the last known state of UV 800, as well as knowledge about its mission and its plans. The continued operation of such Brain and Arena reflections allow information about the UV 800 to be kept substantially up-to-date despite obstructed communication. An example of this information might be knowledge about the current fuel use of UV 800, which is derived from the progress of UV 800 in its current mission. After communication with UV 800 is re-established, the Brain and Arena reflections are updated to reflect the true state of UV 800.

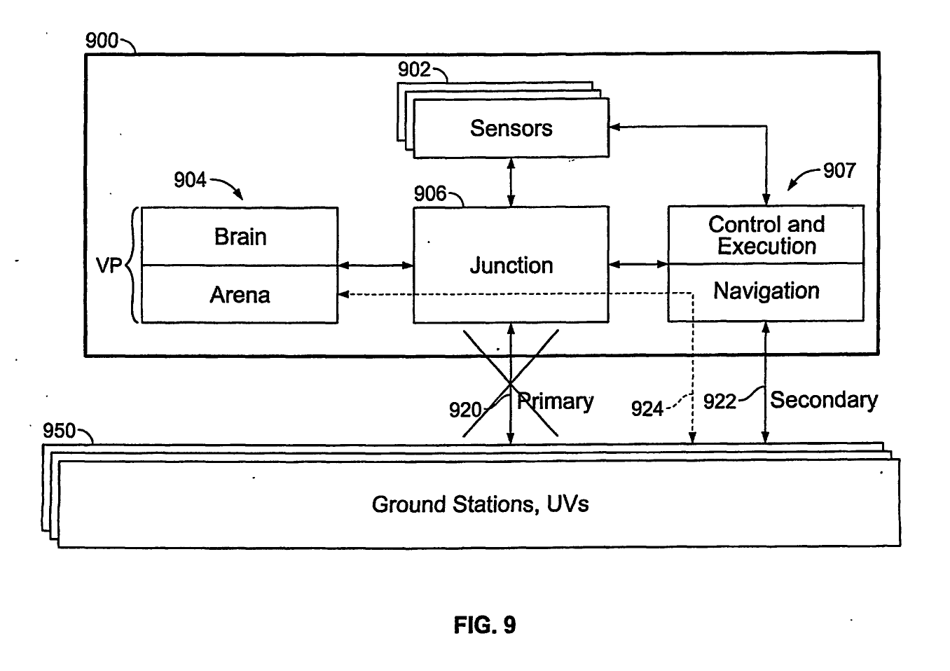

FIG. 9 shows illustrative backup measures for handling primary communication failure in accordance with the invention. The failure of primary communication channel 920 is indicated by an X through channel 920 in FIG. 9. In this scenario, UV 900 is still able to perform its normal functions. Sensors 902 function substantially as if the primary communication channels were still present. In addition, junction 906 is still able to facilitate communication between sensors 902, VP 904, and controller module 907. However, VP 904 now has to rely on secondary communication channels 922 to communicate with ground stations and other UVs 950, by sending messages through junction 906 and controller module 907. This logical connection is indicated by dotted arrow 924. Although secondary communication channels 922 may not have enough bandwidth to transmit all of the information previously carried by the primary communication channels, it should be sufficient for most purposes, and will result in only a partial degradation in performance.

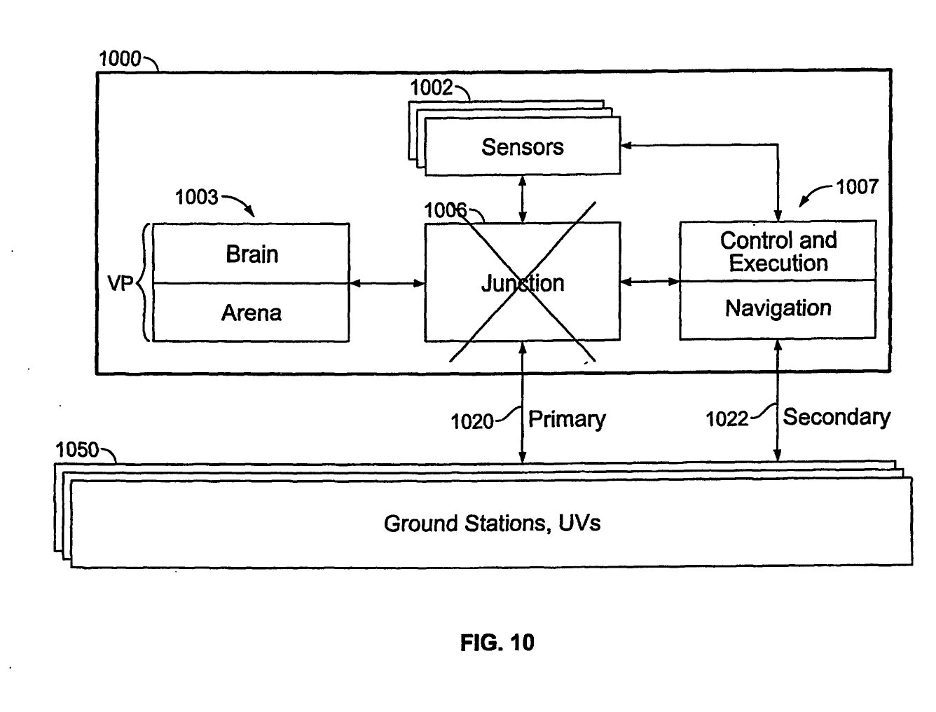

FIG. 10 shows illustrative backup measures for handling junction failure in accordance with the invention. The failure of junction 1006 is indicated by an X through junction 1006 in FIG. 10. Because the junction is an important element in communication between the various components of a UV, as well as with ground stations and other UVs, its failure is likely to significantly degrade the performance of UV 1000. In this scenario, VP 1003 and primary communication channel 1020 may still be functional, but access to them has been eliminated by the failure of junction 1006. However, the performance degradation of UV 1000 is only partial in nature. Sensors 1002 are still able to communicate directly with controller module 1007. In addition, UV 1000 still has access to the Brain and Arena reflections maintained in ground stations and other UVs 10050 through secondary communication channel 1022.

Unfortunately, because secondary communication channel 1022 often has lower bandwidth than primary communication channel 1020, secondary communication channel 1022 is not well-suited to the intensive communication between controller module 1007 and a VP. In FIGS. 8 and 9, the VP (or reflected VP) and the controller module were able to communicate either through a primary communication channel or through onboard communications using the junction. Now, because the bandwidth on secondary channel 1022 is limited, VP 1000 probably will have to restrict its communications with ground stations and other UVs 1050 to low-level information (e.g., equipment status). Although human control at the ground stations remains at a relatively high level, the system is no longer able to rely on a VP to make the necessary decisions normally associated with a pilot. This situation is similar to the normal operation of a traditional UV, where the UV has a very low degree of autonomy. Thus, if a junction module fails as in the example of FIG. 10, the safest course of action might be to bring the UV back to a base for repair.

The backup scenarios shown in FIGS. 8-10 illustrate the gradual performance degradation enabled by the invention. In any given failure scenario, the UV makes the most of its remaining resources, including Brain and Arena reflections maintained in ground stations and other UVs in the same swarm. Significantly, the human user (e.g., field user 356 in FIG. 3) does not need any additional knowledge to handle these scenarios. In one embodiment, the user simply has to respond to yes/no questions posed by the VP of a particular UV. The user may take initiative and order the VP to perform certain tasks or modify its settings if the user feels that there is a need to do so. However, at no point is a human user required to perform low-level operations (e.g., those of a human pilot or a UV commander). This arrangement makes it easier to plan for inevitable failures, because additional staff with more extensive training is not required.

As previously mentioned, one advantage of the invention is reduced reliance on communication. Because the VP is typically provided onboard the UV, the amount of communication required between the UV and outside parties (e.g., ground stations and other UVs in the swarm) is dramatically reduced. Also, because the VP takes care of most of the routine, low-level decision making, temporary lapses in communication are often tolerable, and may not significantly affect mission performance. In an embodiment of the invention, additional optimizations can be applied to further reduce the amount of communication required. For instance, compression of transmitted data (e.g., video, coordinates, and statistics) before transmission can significantly reduce the data volume. Other techniques can also be used, such as those described below.

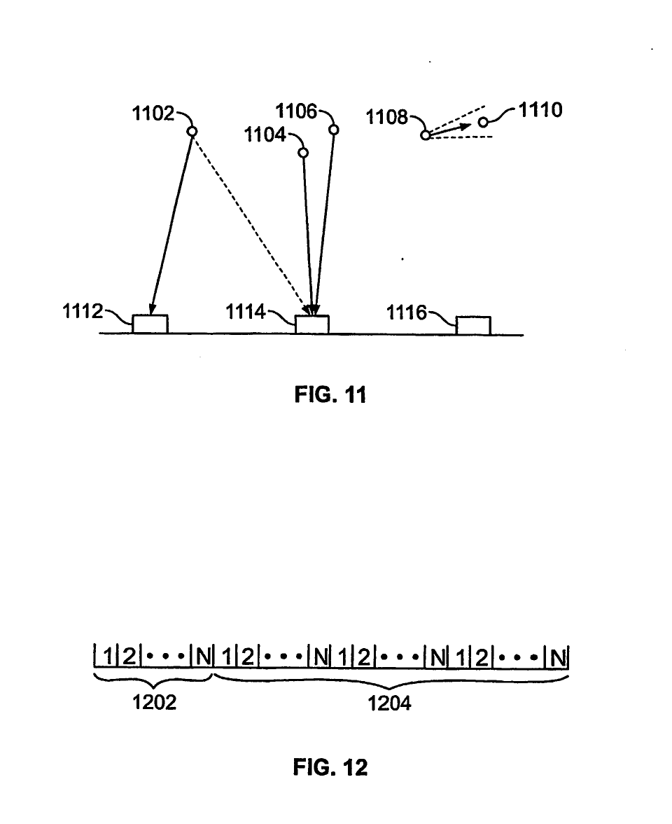

FIG. 11 shows an illustrative communication scenario for a multi-UV system. UVs 1102, 1104, 1106, 1108, and 1110 belong to the same swarm, while ground stations 1112, 1114, and 1116 are available for use by those UVs. UVs and ground stations are referred to, collectively, as “participants.”

In typical wireless communication, participants can communicate with other participants by broadcasting signals. Participants within a certain radius of the sender are able to receive and interpret those signals. Unfortunately, sometimes two senders will transmit to the same participant at substantially the same time. For instance, in the example shown in FIG. 11, UVs 1104 and 1106 may both want to transmit to ground station 1114. If their transmissions overlap in time, those transmissions may interfere with each other and make the transmitted signals unusable. Of course, the nature of the interference will depend on various conditions. For example, if the signal of UV 1104 undergoes relatively little attenuation before reaching ground station 1114, while the signal of UV 1106 undergoes relatively severe attenuation, the transmission of UV 1104 may simply overpower that of UV 1006 when received by ground station 1114.

The danger of interference is made more acute by the fact that transmissions often reach several participants, including some who were not intended to receive the message. Although the message can indicate its intended recipient, so that a given recipient can easily discard messages not intended for it, the fact that messages are reaching many recipients makes it more likely that an interference will occur. For instance, UV 1102 may intend to communicate with ground station 1112, but its signal may reach ground station 1114 as well, potentially interfering with the transmissions of UV 1104 or UV 1106. This possibility is indicated by the dotted arrow between UV 1102 and ground station 1114.

This problem is relieved slightly by the use of directional transmitting antennas with a specific beam shape, such as shown by the dotted lines extending from UV 1108. In such a scenario, UV 1108 can communicate with its intended recipient 1110 with a smaller chance of an unintended recipient also getting the message. Even with the use of directional antennas, however, the probability of interference is still significant, especially if the signals are transmitted frequently.

One approach to avoiding interference would be to use a communication protocol such as time-division multiplexing (“TDM”), where each participant is allowed to transmit only during certain pre-allocated time slices. An example of a TDM protocol is time-division multiple access (“TDMA”), which is commonly used for communication in cellular phone networks. For instance, assume that there are 10 participants in a system, and a time slice is set to be 20 milliseconds (“ms”) in duration. Then in any given second, the first participant could transmit in the 1^{st}, 11^{th}, 21^{st}, 31^{st}, and 41^{st} time slices. Similarly, the second participant could transmit in the 2^{nd}, 12^{th}, 22^{nd}, 32^{nd}, and 42^{nd} time slices. Because there is only one transmitter active at any given time, there can be no interference. Unfortunately, in a system where communication is unpredictable, using TDM communication could be very wasteful. For instance, one participant might be transmitting video, while all the other participants are idle. If that one participant uses only its assigned time slices, many time slices that that one participant could be using are wasted because they are assigned to others who are idle.

In accordance with the invention, a communication scheme designed to make more efficient use of idle time slices is applied. In the discussion below, it is assumed that there are N participants in the system, where each participant is a UV or a ground station. In addition, it is assumed that each participant can simultaneously transmit and receive data on separate channels. Participants may move around continuously during communication. Finally, it is assumed that each participant has enough memory and computational power to maintain state information about all other participants in the system, as required to perform the calculations described below. For instance, such an assumption is appropriate if there are a small number of participants in the system, and the state information is efficiently represented. This assumption is also appropriate if the messages are not sent very frequently. The state information about other participants in the system preferably include a commitment by the other participants to remain silent during certain time slices. If another participant intends to transmit during a given time slice, the transmitted state information preferably includes the intended recipient of that transmission.

FIG. 12 shows an illustrative time division scheme for a communication scheme in accordance with the invention. For instance, FIG. 12 may show that a single second, or any other suitable period of time, can be divided into a first portion 1202 and a second portion 1204. Portion 1202 includes one time slice for each of the N participants. These time slices are preferably dedicated to traditional TDM usage, where each participant is allowed to transmit only during its assigned time slices. Note that, although portion 1202 includes only one slice for each participant, the time slices can be cyclically repeated as desired.

In accordance with the invention, portion 1204 includes additional time slices, each of which is nominally assigned to a respective one of the N participants, again in a cyclic fashion. However, any participant can transmit in any of these slices included in portion 1204. In a preferred embodiment, each participant transmits in a given slice among portion 1204 with a certain probability, where this probability tends to be higher if the slice is assigned to the transmitting participant. The probability of transmission takes into account the probability of interference with another sender at the chosen recipient. That is, if a participant wants to transmit in a given slice, it will calculate the probability of an interference at the chosen recipient (as explained below) and transmit only if that probability is sufficiently low. The probabilities are stored in a matrix on each participant of dimensions N×N×m. Each entry in the matrix stores the probability of an interference from one of the N participants (the sender) at another of the N participants (the recipient) in time slice m. It should be noted that m need not be an integral multiple of N. As described below, other factors may be taken into account, such as the urgency of the messages to be sent.

Of course, such a back-off scheme can result in deadlock if each of two competing senders defers to the other. In order to remedy this situation, a sender can default to using a TDM scheme during portion 1202 if interference is likely and the messages to be sent are relatively urgent. If the messages are of a relatively low urgency, the potential sender will preferably wait for a chance to send in portion 1204. Examples of non-urgent messages include updates where no significant change is reflected, such as a message that the fuel level for a given UV is still within acceptable limits. In contrast, an update stating that a UV's fuel level has just dropped below a critical level would probably be classified as urgent.

In accordance with the invention, this communication scheme does not require perfect delivery of messages to be effective. If non-urgent messages do not reach the intended participants, the overall UV system can continue to function satisfactorily. This probabilistic scheme avoids the complexity of previously known, dynamic wireless communication schemes, which typically involve request-to-send (“RTS”) signals, clear-to-send (“CTS”) signals, acknowledgements (“ACKs”) of sent data, and the like. As noted above, urgent messages will use a conservative TDM scheme that effectively guarantees transmission, unless communication is impossible (e.g., because of obstruction by obstacles, moving out of range, etc.).

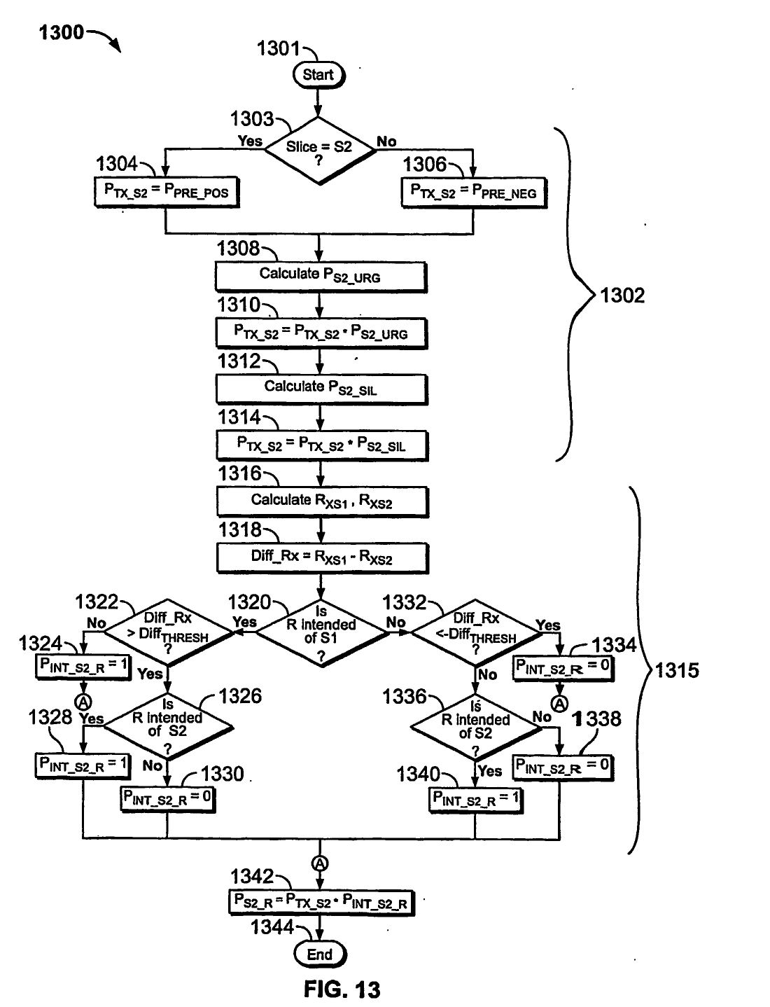

FIG. 13 shows an illustrative calculation of an interference probability in accordance with the invention. The notation for this method is as follows. Participant S1 is the participant that wishes to send a message, and on which this calculation occurs. R is a potential recipient of a message from S1. S2 is another participant, whose transmission may or may not interfere with a transmission from S1.

Method 1300 computes P_{S2}_{_{—}}_{R}, which is the probability that a transmission from S2 will interfere with a transmission from S1 to R in a particular time slice. As defined in step 1342, P_{S2}_{_{—}}_{R}=P_{TX}_{_{—}}_{S2}*P_{INT}_{_{—}}_{S2}_{_{—}}_{R}, where P_{TX}_{_{—}}_{S2} is the probability that S2 will transmit in the given time slice, and P_{INT}_{_{—}}_{S2}_{_{—}}_{R} is the probability of an interference from S2 at R, given that S2 is transmitting in the given time slice. P_{TX}_{_{—}}_{S2} is computed in steps 1301 of method 1300, while P_{INT}_{_{—}}_{S2}_{_{—}}_{R} is computed in steps 1315 of method 1300. Other notation used in method 1300 will be explained as it is introduced.

Method 1300 starts at step 1301. At step 1303, S1 determines whether the time slice under consideration corresponds to participant S2. If so, then P_{TX}_{_{—}}_{S2} is set to P_{PRE}_{_{—}}_{POS}, a relatively high probability, at step 1304. If not, then P_{TX}_{_{—}}_{S2} is set to P_{PRE}_{_{—}}_{NEG}, a relatively low probability, at step 1306. After this preliminary value of P_{TX}_{_{—}}_{S2} is set, the method proceeds to step 1308, where P_{S2}_{_{—}}_{URG} is calculated. P_{S2}_{_{—}}_{URG} is a factor between 0 and 1 reflecting the urgency of a message to be sent in the given time slice. Given P_{S2}_{_{—}}_{URG}, P_{TX}_{_{—}}_{S2} is set to P_{TX}_{_{—}}_{S2}*P_{S2}_{_{—}}_{URG} at step 1310. This calculation simply reflects the fact that S2 is more likely to transmit if its message is urgent. In a preferred embodiment of the invention, only messages whose urgency level is above a certain threshold are considered at step 1308; messages with an urgency below that threshold are filtered out beforehand.

At step 1312, P_{S2}_{_{—}}_{SIL} is calculated. P_{S2}_{_{—}}_{SIL} represents the commitment of S2 to remain silent during the time slice in question, and again falls between 0 and 1. In an embodiment of the invention, variables such as P_{S2}_{_{—}}_{SIL} are exchanged between participants using deterministic TDM portion 1202. Such communications convey, for example, a commitment not to transmit a message during the next T time slots. Of course, such a message is only binding until the next update is sent, at which time the commitment may be changed. In an embodiment of the invention, P_{S2}_{_{—}}_{SIL} will be either 0 or 1, reflecting a binary commitment to either remain silent or transmit. Given P_{S2}_{_{—}}_{SIL}, P_{TX}_{_{—}}_{S2} is set to P_{TX}_{_{—}}_{S2}*P_{S2}_{_{—}}_{SIL} at step 1314.

Having computed P_{TX}_{_{—}}_{S2} in steps 1302, the method proceeds to steps 1315, which compute P_{INT}_{_{—}}_{S2}_{_{—}}_{R}. At step 1316, Rx_{S1} and RX_{S2} are computed. Rx_{S1} is the power at receiver R of a signal transmitted from S1, and takes into account various factors, including the transmission power of S1; the attenuation of the medium between S1 and R; the distance between S1 and R; the gain of S1's transmitting antenna in the direction of R; the gain of R's receiving antenna in the direction of N1; and the existence of an unobstructed path between S1 and R. Of course, corresponding factors are taken into account in computing RX_{S2}. Given Rx_{S1} and RX_{S2}, we compute their difference as Diff_RX_{S1}−RX_{S2} in step 1318. Diff_Rx, preferably measured in decibels (reflecting a logarithmic scale), reflects the relative strength of transmissions by S1 and S2 at receiver R.

At step 1320, it is determined whether R is an intended recipient of a message from S1. If so, then the method proceeds to step 1322, where it is determined whether Diff_Rx is greater than Diff_{THRESH}, which is a pre-determined threshold for the difference in power at the receiver. If Diff_Rx is not greater than Diff_{THRESH}, that means that a transmission from S1 is likely to experience interference from S2 if S2 transmits substantially simultaneously. That is, transmissions from S1 and S2 may be of comparable power at R, in which case R may not receive any meaningful data during the interference period, or S2's transmission may simply overpower S1's transmission at R, in which case S2's transmission is received but S1's transmission is lost. There is interference from S2 in both of these cases, so P_{INT}_{_{—}}_{S2}_{_{—}}_{R} is set to 1 at step 1324. The method then proceeds to A.

On the other hand, if Diff_Rx is greater than Diff_{THRESH}, the method proceeds to step 1326, where it is determined whether or not R is an intended recipient of S2's messages. If yes, the method proceeds to step 1328, where P_{INT}_{_{—}}_{S2}_{_{—}}_{R} is set to 1. This step reflects the desire for participant S1 to cooperate with other participants, and not interfere with the transmissions of other senders. That is, setting P_{INT}_{_{—}}_{S2}_{_{—}}_{R} to 1 makes it unlikely that S1 will transmit during this time slice, thereby reducing the chance that S1 will interfere with a message from S2 to R. After step 1328, the method proceeds to A. On the other hand, if R is not an intended recipient of S2's messages, then a transmission from S1 to R is likely to overpower any transmission from S2 to R, without interfering with an effort from S2 to transmit to R. In this case, P_{INT}_{_{—}}_{S2}_{_{—}}_{R} is set to 0 at step 1330, and the method proceeds to A.

Now, suppose that R is not an intended recipient of S1, as determined in step 1320. Then the main concern becomes not interfering with a transmission from S2 to R. The method proceeds to step 1332, where it is determined if Diff_Rx is less than −Diff_{THRESH}. If it is, then P_{INT}_{_{—}}_{S2}_{_{—}}_{R} is set to 0 at step 1332. Since S1's transmission power at R is sufficiently weaker than S2's transmission power at R, it is acceptable for S1 to transmit to R1 which is consistent with setting a low interference probability P_{INT}_{_{—}}_{S2}_{_{—}}_{R}. After step 1334, the method proceeds to A.

On the other hand, if it is determined that Diff_Rx is not less than −Diff_{THRESH}, the method proceeds to step 1336, where it is determined if R is an intended recipient of S2. If not, the P_{INT}_{_{—}}_{S2}_{_{—}}_{R} is set to 0 at step 1338. In this case, although a transmission from S1 to R may interfere with a transmission from S2 to R, because R is not an intended recipient of S2, it is still acceptable for S1 to transmit. After step 1338, the method proceeds to A. Finally, if R is not determined to be an intended recipient of S2 at step 1336, then P_{INT}_{_{—}}_{S2}_{_{—}}_{R} is set to 1 at step 1340. In this case, a transmission from S1 to R is likely to interfere with an intentional transmission from S2 to R, so P_{INT}_{_{—}}_{S2}_{_{—}}_{R} is set so as to make S1's transmission less likely. After step 1340, the method proceeds to A. Note that, although P_{INT}_{_{—}}_{S2}_{_{—}}_{R} is set to either 0 or 1 in the description above, P_{INT}_{_{—}}_{S2}_{_{—}}_{R} can also be set to a fractional value (e.g., a value based on Diff_Rx).

At point A, P_{TX}_{_{—}}_{S2} has been set in steps 1302 and P_{INT}_{_{—}}_{S2}_{_{—}}_{R} has been set in steps 1315. Thus, P_{S2}_{_{—}}_{R} can be computed as P_{TX}_{_{—}}_{S2}*P_{INT}_{_{—}}_{S2}_{_{—}}_{R} in step 1342. Recall that P_{S2}_{_{—}}_{R} is the probability that a transmission from S1 to R will experience interference from S2 at R. This final probability is computed for all participants S2 and R in the system, and stored in the appropriate location in the matrix of dimensions N×N×m. At step 1344, method 1300 is terminated.

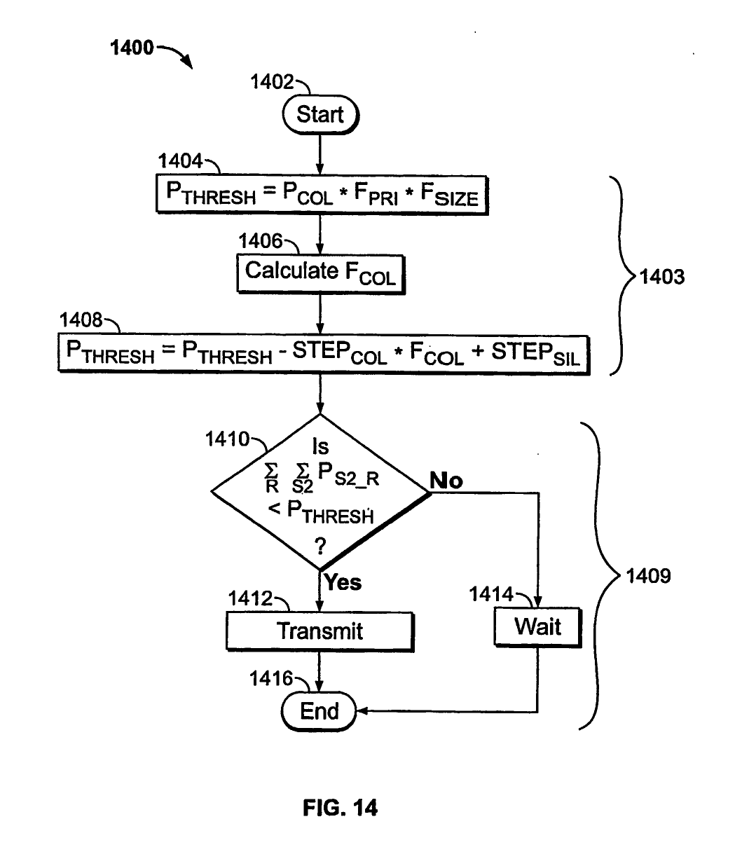

FIG. 14 is a flow chart showing an illustrative decision of whether or not a given participant should transmit in accordance with the invention. In steps 1403, a probability threshold P_{THRESH} is calculated. In steps 1409, values of P_{INT}_{_{—}}_{S2}_{_{—}}_{R} and P_{THRESH} are used to determine whether or not S1 can transmit to R in a given time slice, with a relatively low chance of interference from another participant.

Method 1400 starts at step 1402. At step 1404, P_{THRESH} is set to an initial value of P_{COL}*F_{PRI}*F_{SIZE}. Here, P_{COL} represents an acceptable probability of collisions for low priority messages. F_{PRI} is a factor accounting for the priority of S1's messages, and F_{SIZE} is a factor reflecting the number of messages of the highest priority waiting to be sent. Both F_{PRI} and F_{SIZE} preferably take values between 0 and 1.

At step 1406, F_{COL} is calculated. F_{COL} is the fraction of messages sent from S1 resulting in a collision at an intended recipient, measured over a certain time window. Because recipients are in the best position to detect a collision, F_{COL} is calculated from information received from recipients. That is, each participant in the network maintains a log of whether or not it received a collision in each time slot. This log can be maintained over any suitable number of time slots, and collisions can be detected using any suitable method (e.g., examining checksums, measuring signal voltage, etc.). Each participant then broadcasts its collision log to the other participants periodically. Participant S1 then computes F_{COL} by examining these logs and recording how many collisions occurred in slots that S1 transmitted in, at S1's intended recipient during that slot.

Having computed F_{COL} at step 1406, P_{THRESH} is then modified at step 1408 by subtracting STEP_{COL}*F_{COL} and adding STEP_{SIL}. STEP_{COL} is an increment designed to adjust P_{THRESH} according to its collision history. By subtracting STEP_{COL}*F_{COL}, P_{THRESH} is decreased by an amount proportional to how many collisions it has generated in the recent past. STEP_{SIL} is an increment whose value is preferably small relative to that of STEP_{COL}. Adding STEP_{SIL} to P_{THRESH} will slowly raise P_{THRESH} over the course of many iterations if F_{COL} (and thus STEP_{COL}*F_{COL}) is relatively small.

After steps 1403 are completed, P_{THRESH} has been computed. Method 1400 then proceeds to steps 1409, where the final transmission decision is made. At step 1410, the values of P_{S2}_{_{—}}_{R} are summed over all values of S2 and R for this time slice. The resulting sum approximates the probability that at least one desired interference will happen if S1 transmits to R. If this sum is less than P_{THRESH}, then transmission can occur at step 1412. Otherwise, S1 will wait at step 1414. It should be noted that, if information on a given participant is incomplete (e.g., because that participant is out of range and is unable to send updates), the communication scheme preferably operates in a conservative fashion, assuming this participant will transmit in any given time slice.

The communication scheme presented in FIGS. 12-14 result in efficient usage of the communication spectrum in accordance with the invention. Bandwidth is utilized effectively by utilizing probabilistic metrics to avoid interference. Preferably, only low urgency messages are sent with this probabilistic approach, since their receipt is not crucial to the operation of the UV system. Urgent messages can be sent using a traditional TDM scheme, which provides greater reliability.

It should be noted that, although the discussion above has focused on the sharing of time slices, in a protocol based loosely on TDM, the communication scheme of the invention can also be used for other types of multiplexing. For instance, in a frequency division scenario, the communication scheme of the invention could be applied to enable transmission at a frequency nominally allocated to another participant. In this case, the protocol of the invention would be based loosely on frequency division multiplexing (“FDM”). More generally, concepts of the invention can be applied to scenarios granting access to any type of shared channel, including scenarios using TDM, FDM, or code division multiplexing (“CDM”), where the information is transmitted according to a correlation code. Indeed, more than one of these techniques can even be combined if desired (e.g., if network congestion is high). For instance, sharing can occur across both time slices and frequencies. In addition, it should be noted that although the communication scheme has been described in the context of communication between and among UVs and ground stations, it can be applied to any network where a transmission from one participant may interfere with a transmission from another participant.

Thus it is seen that methods and apparatus are provided to enable a UV to operate with little or no guidance from human operators. Methods and apparatus are also provided to reduce the amount of communication required by LTs, as well as the amount of human control involved in UV missions. One skilled in the art will appreciate that the invention can be practiced by other than the described embodiments, which are presented for purposes of illustration and not of limitation, and the present invention is limited only by the claims which follow.

What is claimed is:

1. A method for controlling an unmanned vehicle (“UV”) with a state machine on said UV, said method comprising:
entering a state of said state machine;
receiving an input on said UV;
evaluating a condition of a rule corresponding to said state using said input;
performing at least one action corresponding to said rule based on a result of said evaluating; and
modifying said state machine.

2. The method of claim 1 wherein said modifying is responsive to said performing at least one action.

3. The method of claim 1 wherein said modifying alters a transition of said state machine.

4. The method of claim 1 wherein said modifying alters a rule of a state of said state machine.

5. The method of claim 4 wherein said altering said rule comprises altering a condition of said rule.

6. The method of claim 1 wherein said performing at least one action comprises altering navigation of said UV.

7. The method of claim 6 wherein said altering navigation comprises rotating a servo of said UV.

8. The method of claim 1 wherein said receiving of said input comprises receiving data from a sensor mounted on said UV.

9. The method of claim 8 wherein said sensor is configured to measure the status of onboard equipment on said UV.

10. The method of claim 8 wherein said data comprise data indicative of a position of said UV.

11. The method of claim 1 wherein said receiving of said input comprises receiving data from a camera mounted on said UV.

12. The method of claim 11 further comprising transmitting said data from said camera to a ground station.

13. The method of claim 1 wherein said performing at least one action comprises setting a second input.

14. The method of claim 13 further comprising evaluating a condition of a second rule using said second input.

15. A method for managing a first participant in a network of unmanned vehicles (“UVs”) and ground stations, wherein said network includes at least one other participant, said method comprising:
maintaining first state information about said first participant;
transmitting an update of said first state information to said at least one other participant;
maintaining second state information about said at least one other participant; and
receiving an update of said second state information from said at least one other participant.

16. The method of claim 15 wherein:
said first state information includes information received from a sensor mounted on said first participant; and
said second state information includes information received from a sensor mounted on said at least one other participant.

17. The method of claim 15 wherein:
said first state information includes information about a mission status of said first participant; and
said second state information includes information about a mission status of said at least one other participant.

18. The method of claim 15 further comprising sending a command to one of said at least one other participant.

19. The method of claim 18 wherein said command affects navigation of said one of said at least one other participant.

20. The method of claim 15 wherein said transmitting said update comprises:
determining a probability that said update will experience interference from one of said at least one other participant in a channel;
comparing a quantity based on said probability to a threshold; and
transmitting in said channel when said quantity is less than said threshold.

21. The method of claim 20 wherein said threshold is based on a message indicative of whether said one of said at least one other participant will transmit during said channel.

22. The method of claim 20 wherein said determining a probability comprises determining an urgency of a message from said one of said at least one other participant.

23. A system for controlling an unmanned vehicle (“UV”) with a state machine on said UV, said system comprising:
a sensor mounted on said UV;
a controller module mounted on said UV and coupled to said sensor;
a junction mounted on said UV coupled to said sensor and said controller module; and
a command unit mounted on said UV and coupled to said junction, wherein:
said command unit is configured to control said UV using said controller module based on information from said sensor.

24. The system of claim 23 wherein said command unit is configured to execute a state machine that is responsive to information from said sensor.

25. The system of claim 24 wherein said state machine can modify itself responsive to information from said sensor.

26. The system of claim 23 further comprising a second participant coupled to said junction through a primary channel and coupled to said controller module through a secondary channel.

27. The system of claim 26 wherein said second participant comprises a UV.

28. The system of claim 26 wherein said second participant comprises a ground station.

29. The system of claim 26 wherein said command unit is configured to communicate with said second participant through said junction and said primary channel.

30. The system of claim 29 wherein said command unit is configured to communicate with said second participant through said junction, said controller module, and said secondary channel when said primary channel is disabled.

31. The system of claim 29 wherein said second participant stores information based on information stored on said command module.

32. The system of claim 31 wherein said information stored on said second participant is configured to control said UV using said controller module based on information from said sensor when said command unit is disabled.

33. A method of communicating between a first sender and a recipient, said method comprising:
determining a probability that a communication from a second sender will interfere with a communication from said first sender to said recipient in a channel;
comparing a quantity derived from said probability to a threshold; and
communicating between said first sender and said recipient in said channel based on a comparison of said derived quantity to said threshold.

34. The method of claim 33 wherein said determining said probability comprises determining a position of said second sender.

35. The method of claim 33 wherein said determining said probability comprises determining whether said second sender intends to communicate in said channel.

36. The method of claim 33 wherein said determining said probability comprises determining a message urgency of said second sender.

37. The method of claim 33 further comprising:
determining that said communicating from said first sender to said recipient is of a relatively high urgency; and
using a channel assigned to said first sender to perform said communicating.

38. The method of claim 33 wherein:
said channel is assigned to a sender; and
said determining a probability comprises determining whether said channel is assigned to said second sender.

39. The method of claim 38 wherein:
said probability is set to a first value when said channel is assigned to said second sender; and
said probability is set to a second value when said time slice is not assigned to said second sender.

40. The method of claim 33 wherein said channel comprises a time slice.

41. The method of claim 33 wherein said channel comprises a frequency.

42. The method of claim 33 wherein said channel comprises a set of frequencies whose selection is based on a correlation code.

43. The method of claim 33 wherein:
said channel comprises a time slice;
said communicating occurs at at least one frequency; and
said at least one frequency is selected based on a correlation code.

44. A system for controlling an unmanned vehicle (“UV”) with a state machine on said UV, said system comprising:
means for entering a state of said state machine;
means for receiving an input on said UV;
means for evaluating a condition of a rule corresponding to said state using said input;
means for performing at least one action corresponding to said rule based on a result of said evaluating; and
means for modifying said state machine.

45. A system for managing a first participant in a network of unmanned vehicles (“UVs”) and ground stations, wherein said network includes at least one other participant, said method comprising:
means for maintaining first state information about said first participant;
means for transmitting an update of said first state information to said at least one other participant;
means for maintaining second state information about said at least one other participant; and
means for receiving an update of said second state information from said at least one other participant.
